(19) United States
(12) Patent Application Publication
(10) Pub. No.: US 2026/0286130 A1
(43) Pub. Date: Sep. 24, 2026

(54) SILICONE IMPRESSION MATERIAL WITH ACCELERATED CURING

(71) Applicant: KULZER GMBH, Hanau (DE)

(72) Inventors: Andreas Grundler, Münzenberg (DE); Michael Hendrich, Bad Homburg (DE); Peter Deutzmann, Rommerskirchen (DE); Roman Hamburg, Niddata-llbenstadt (DE); Peter KUNZE, Nümbrecht (DE)

(73) Assignee: KULZER GMBH, Hanau (DE)

(21) Appl. No.: 19/164,387

(22) PCT Filed: Mar. 11, 2024
(86) PCT No.: PCT/EP2024/056372

§ 371 Date: Sep. 11, 2025

(30) Foreign Application Priority Data
Mar. 13, 2023 (DE) 10 2023 106 163.1

(51) Int. Cl. C08L 83/04; B01J 23/42; C08K 3/36

(52) U.S. Cl. CPC C08L 83/04; B01J 23/42; C08K 3/36; C08L 2205/02

(57) ABSTRACT

Curable and/or cross-linkable compositions are disclosed and comprise addition-cross-linkable terminal ethylene-group-containing polydialkyl siloxanes and Si—H-group-containing polydialkyl siloxanes having a specific Si—H group content in relation to ethylene groups.

The invention relates to a curable composition comprising addition-crosslinkable polydialkylsiloxanes comprising at least two terminal ethylene groups and polydialkylsiloxanes comprising at least two Si—H groups with a specific content of Si—H groups in molar ratio to ethylene groups.

Dental impression materials are commonly used to reproduce the spatial position of teeth and jaws. Depending on the type of impression, the impression material placed in an impression tray remains in the patient's mouth for varying lengths of time. Many patients find this step very unpleasant, as it can impair breathing, among other things. This can lead to gagging or anxiety and, in some cases, to the impression being abandoned. The aim is to accelerate the hardening of an impression material and thus shorten the time it remains in the patient's mouth. At the same time, a processing time must be maintained in order to be able to mix and apply the impression materials. Furthermore, a high level of detail must be achieved in the impression. To this end, these impression materials must flow as well as possible around the tooth and surrounding tissue, even in the moist environment of the mouth.

WO 2013/025494 A1 discloses addition-curing silicone impression materials consisting of hydride-functional and vinyl-terminated siloxanes which cross-link under Pt catalysis. The impression materials heat up due to the addition of low-molecular-weight allyl silanes during the cross-linking process. These allyl silanes are also already added in U.S. Pat. No. 7,700,712 B2. This heating is caused by a reaction of the allyl silanes with the hydride-functional siloxanes contained in addition-curing silicones. WO 2013/025494 A1 states that this heating results in a shortened setting reaction.

However, due to their low molecular weight, the added allyl silanes are associated with two inherent disadvantages. The reaction of allyl silanes with hydride-functional siloxanes is very efficient, which, according to WO 2013/025494 A1, can result in a temperature increase of up to 20° C. In our opinion, this is more likely to be perceived as unpleasant or threatening by patients and may trigger anxiety or defensive reactions in them. Furthermore, the allyl silanes used are monofunctional and therefore cannot contribute to the formation of a silicone network, i.e., effective curing or cross-linking.

The aim of the invention was to provide curable compositions of addition-crosslinking polysiloxanes that set faster within a defined time window and are still easy to work with before this time window. In particular, the compositions should not cause any unpleasant temperature increases despite their fast setting. A temperature increase of 10° C. or more is considered unpleasant. In addition, the impression materials should continue to exhibit high detail accuracy and flow well in the moist oral environment around the tooth and surrounding tissue.

The tasks were solved by an addition-crosslinking composition according to claim 1, preferred embodiments are disclosed in the subclaims and in more detail in the description. The invention also relates to a kit according to claim 18 comprising a 2K dispensing device comprising at least two cartridges and the use according to claim 19.

The present invention describes impression materials which, compared to the prior art, have a shortened setting time, in particular shorter time windows for the hardening reaction, and preferably at the same time have a low temperature increase.

It has been found that for efficient network formation, i.e., fast curing reaction (t₉₀−t₅) as the difference between setting time (t₉₀) and processing time (t₅), must be adjusted, whereby at least two specific polysiloxane compositions with different contents of polysiloxanes comprising at least two Si—H groups are used to adjust the ratio of hydride-functional polysiloxanes. Furthermore, it has proven to be disadvantageous if monounsaturated compounds are present in the composition, such as low molecular weight species comprising, for example, monounsaturated compounds with H₂C═CH—CH₂—, H₂C═C(CH₃)—CH₂— groups or monounsaturated compounds of formula I. It has been found that the presence of monounsaturated compounds in particular leads to an increase in the reaction temperature and apparent acceleration of the addition crosslinking reaction with competing reactions without accelerating the curing. Here, the curing is correlated with the crosslinking reactions. According to the invention, the decisive factor is the adjustment of a specific ratio of hydride- and vinyl-functional siloxanes.

For the additive crosslinking reaction of hydride-functional polysiloxanes contained in the base component and vinyl-terminated polysiloxanes that may be contained in the base and catalyst components, these must be able to coordinate with a platinum catalyst. It has now been found that a specific ratio of at least two polysiloxane compositions, each with a defined molar content of Si—H groups in a specific ratio to polysiloxanes with at least two terminal ethylene groups, leads to accelerated curing (synonymous with hardening or crosslinking) of the composition containing the addition-crosslinkable polysiloxanes. It has also been found that increasing the reaction temperature to accelerate the addition reaction disproportionately delays the addition reaction due to the resulting competitive reaction with the monounsaturated compound of formula I and leads to unfavorable setting behavior and/or unfavorable time course of the curing reactions of the composition.

The time window for the hardening reaction is characterized by the time difference t₉₀−t₅. Here, t₅ corresponds to the processing time, i.e., the time until which an approximately stress-free deformation of the impression material is still possible. The time t₉₀ corresponds to the setting time, i.e. the point in time at which a large part of the network has formed and only minimal deformation of the material is possible. Ideally, the time difference t₉₀-t₅ should be as short as possible so that the impression can be removed from the patient's mouth quickly. The times are determined by measuring the viscosity of the mixed impression material at 30° C. using a rheometer. The setting time of the compositions was determined by measuring the viscosity as a function of time at 30° C. using a rheometer, as specified below. The total time was determined as the t₉₀-value (setting time) at which 90% of the final viscosity of the complex viscosity was reached from the start of mixing. Another characteristic value is the t₅-value (processing time) at which 5% of the final viscosity of the complex viscosity is present. Up to this point in time t₅-value (processing window/time), it is assumed that essentially no network formation has yet taken place in the composition (no curing). The difference t between the setting time t₉₀ and the processing time t₅ is calculated according to
t=t₉₀−t₅, the time window defined here for the curing reaction, and corresponds to the transition time from the plastic to the elastic state of the material. The ratio between the processing time t₅ and the transition time t of the material is a measure of the so-called snap-set curing behavior of the material.
t₅ corresponds to the time at which 5% of the final viscosity is reached. t₉₀ corresponds to the time at which 90% of the final viscosity is reached. The measurement ends after 10 minutes. The time window for the curing reaction or cross-linking is defined as t₉₀ minus t₅. The time period before t₅ is reached is defined as the processing window/time. The term “curable composition comprising addition-crosslinkable polysiloxanes” is used synonymously with “crosslinkable composition.”

Furthermore, it is preferred that the time t₅ (synonymous with t5) be at least 0.75 minutes, which in this case always corresponds to industrial minutes (industrial minutes, 60 minutes equals 100 industrial minutes, i.e. =hours+minutes/60+seconds/3600), in order to be able to prepare the mixture of base component and catalyst component, apply the composition in the impression tray, insert the impression tray into the patient's mouth and make any optional corrections. After correct placement of the impression tray in the patient's mouth, particularly rapid curing is desired. This rapid curing is indicated by the time difference t₉₀ minus t₅ in minutes.

According to the invention, a composition is provided which has a time window for significantly faster additive curing or curing reaction of preferably less than 0.90 min for (t₉₀−t₅) in industrial minutes (min.), preferably less than 0.7 min. (t₉₀−t₅) (min).

For compositions comprising allyltrimethylsilane curing reaction time windows (t₉₀−t₅) of 0.94 minutes (allyltrimethylsilane in base paste) and 0.72 minutes (allyltrimethylsilane in catalyst paste) were determined. Compositions without the low-molecular-weight allyl silanes, on the other hand, exhibited a significantly shorter curing time of less than 0.6 minutes and, depending on the Si—H content, as little as 0.33 minutes. In a particularly preferred embodiment, the composition is free of simple and/or multifunctional allyl silanes. The particularly preferred compositions, which are free of single-functional and/or multi-functional allyl silanes, can cure within a curing time of t₉₀−t₅ of less than 0.7 minutes, preferably less than 0.65 minutes, and more preferably less than or equal to 0.55 minutes. In a particularly preferred embodiment, curing can take place within t₉₀−t₅ of less than or equal to 0.4 minutes (industrial minutes). Compositions according to the modified reference examples exhibit a significant temperature increase of over 10° C. Such an extreme temperature increase will cause pain to the patient or be perceived as very unpleasant.

If polysiloxane compositions do not contain allylsilanes, in particular neither monofunctional and/or multifunctional allylsilanes, the result is an unhindered additive curing of the hydride-functional polysiloxanes and vinyl-terminated polysiloxanes. In the present invention, the curing time t₉₀−t₅ can thus be more than halved compared to silicone impression materials containing allylsilane with the same processing time. In addition, excessive heating of the materials, which could be perceived as unpleasant by the patient, is avoided.

The invention relates to a curable composition comprising addition-crosslinkable organo-functional polysiloxanes, in particular selected from
i. addition-crosslinkable polysiloxanes comprising at least two terminal ethylene groups, and
ii. at least two polysiloxanes comprising Si—H groups, in particular polyhydrogen siloxanes, wherein the polysiloxanes comprising Si—H groups comprise at least two polysiloxane compositions with different contents of Si—H groups, wherein a first polysiloxane composition (PS1) has a Si—H group content of 1 to 3.5 mmol/g and a second polysiloxane composition (PS2) has a Si—H group content of 3.8 mmol/g to 15 mmol/g, in particular the first and second and optionally further polysiloxane compositions are present as a mixture, wherein the first polysiloxane composition (PS1) with a content of Si—H groups and the second polysiloxane composition (PS2) with a content of Si—H groups are present in a weight ratio of 1:1.5 to 1:10, in particular in a weight ratio of 1:1.8 to 1:6, and
wherein the molar ratio of Si—H groups of the polysiloxanes to ethylene groups of the polysiloxanes is from 4:1 to 10:1, and optionally comprising a hydrosilylation catalyst, and wherein the composition comprises essentially no monounsaturated compounds, in particular of formula I.

Preferred polysiloxanes comprising at least two Si—H groups have terminal Si—H groups and optionally have pendant Si-groups. Preferred polysiloxanes comprising at least two terminal ethylene groups may optionally additionally comprise side-standing ethylene groups. Particularly preferred polysiloxanes comprising at least two terminal ethylene groups comprise terminal divinyl polysiloxanes, particularly preferred divinyl polydialkylsiloxanes, alkyl with 1 to 6 C atoms, particularly preferred divinyl polydimethylsiloxanes. Polysiloxanes comprising Si—H groups or Si—H groups can also be referred to as polyhydrogensiloxanes.

Preferred hydrosilylation catalysts comprise hydrosilylation catalysts comprising platinum, rhodium and/or palladium.

A further preferred embodiment comprises a composition whose maximum temperature increase (ΔT) during curing is less than or equal to 7° C., preferably less than or equal to 6° C., particularly preferably less than or equal to 5° C., wherein the temperature increase is measured with a temperature sensor in the mass at intervals of 15 seconds from the first mixing until 10 minutes after the first mixing, wherein a temperature measurement is made every 30 seconds in particular.

Furthermore, it is particularly preferred if, alternatively or cumulatively, (ii) the value t₅ in minutes (industrial minutes) of the complex viscosity of 5% of the complex viscosity of the value of the complex viscosity 10 minutes after the start of mixing of the curable composition is less than or equal to 1.7 minutes, preferably less than 1.6 minutes, particularly preferably less than or equal to 1.5 minutes, further preferably less than or equal to 1.4 minutes, and/or (iii) the value t₉₀−t₅ as the difference between the time t₉₀ at 90% of the complex viscosity of the value of the complex viscosity after 10 minutes and the time t₅ at 5% of the complex viscosity of the value of the complex viscosity after 10 minutes, is less than or equal to 1 minute, in particular less than or equal to 0.8 minutes, preferably less than or equal to 0.7 minutes, particularly preferably less than or equal to 0.6 minutes. Further preferred is less than or equal to 0.5 minutes with a deviation of +/−20%, whereby the temperature increase is preferably less than or equal to 6° C., preferably less than or equal to 5° C.

The processing time t₅ in minutes, i.e. the time until which an approximately stress-free deformation of the impression material is still possible, is preferably less than or equal to 1.8 minutes (industrial minutes), preferably less than or equal to 1.6 minutes, particularly preferably less than or equal to 1.5 minutes and preferably greater than or equal to 1 minute, wherein alternatively or additionally the time window of the hardening reaction (t₉₀−t₅) in minutes is less than or equal to 0.9 minutes, preferably less than or equal to 0.85 minutes, particularly preferably less than or equal to 0.7 minutes, wherein optionally at the same time the temperature increase being less than 7° C. It is further preferred that the processing time t₅ in minutes (industrial minutes) is greater than or equal to 0.8 minutes, in particular greater than or equal to 0.9 minutes, and less than or equal to 2 minutes, preferably less than or equal to 1.5 minutes.

Without being bound by theory, it is assumed that the rapid setting with good processing time is achieved by a weight ratio PS1/PS2 (PS1=crosslinking agent with SiH 1.3 to 2.5 mmol/g and PS2=crosslinking agent with SiH 4 to 8 mmol/g) of 1:1.8 to 1:6 and a molar SiH group to vinyl group ratio of 4.5 to 9.3.

The compositions according to the invention correspond to an easily flowable correction impression material, but in principle it can be transferred to all consistencies (type 3-type 0 according to DIN EN ISO 4823:2021, DIN EN ISO 4823:2021-06).

According to a preferred embodiment, the addition-crosslinking polysiloxanes comprising at least two terminal ethylene groups comprise polydialkylsiloxanes, polydialkylsiloxane ethers or mixtures thereof, in particular with alkyl each independently having 1 to 16 C atoms, preferably alkyl having 1 to 4 C atoms, particularly preferred being methyl groups.

Preferably, the composition according to a preferred embodiment essentially does not contain any monounsaturated compound(s), in particular of formula I. Furthermore, the compositions according to a preferred embodiment essentially do not contain any monounsaturated compound of formula I

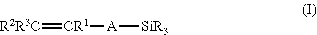

with
R is independently selected from H, a monovalent alkyl group with 1 to 22 C atoms, an aryl group with 16 to 12 C atoms, an O—SiR⁴₃ group, wherein
R optionally comprises heteroatoms, with the provison that R is not an alkoxy group or arylalkoxy group,
R¹, R², R³ are each independently selected from H, monovalent alkyl group with 1 to 22 C atoms, aryl group with 6 to 12 C atoms and optionally each independently comprise heteroatoms,
R⁴ is a monovalent alkyl group with 1 to 22 C atoms or an aryl group with 6 to 12 C atoms, wherein optionally two or three R⁴ groups can form a cyclic or polycyclic structure in O—SiR⁴₃,
A is a bivalent linear, branched or cyclic hydrocarbon group with 1 to 12 C atoms, optionally comprising an aromatic compound with at least one methylene group which is directly covalently bonded to the aromatic compound, optionally comprising
—O-atoms, preferably A is methylene, ethylene, propylene, butylene, hexylene, octylene, nonylene or decylene. A composition containing no single unsaturated compound(s), in particular of formula I, is understood to be a composition which has a maximum content of 0.001 wt.-% in the total composition of 100 wt.-%, the content preferably being 0%.

Compounds of formula I comprise: H₂C═CH—CH₂Si(CH₃)₃ CAS: [762-72-1], H₂C═CH—(CH₂)₂Si(CH₃)₃, H₂C═CH—(CH₂)₃Si(CH₃)₃, H₂C═CH—(CH₂)₄Si(CH₃)₃, H₂C═CH—(CH₂)₈Si(CH₃)₃, H₂C═CH—CH₂Si(i-C₃H₇)₃ CAS: [24400-84-8], H₂C═CH—(CH₂)₂Si(i-C₃H₇)₃, H₂C═CH—(CH₂)₃Si(i-C₃H₇)₃, H₂C═CH—(CH₂)₄Si(i-C₃H₇)₃, H₂C═CH—(CH₂)₂Si(CH₃)₂(t-C₄H₉), H₂C═CH—(CH₂)₃Si(CH₃)₂(t-C₄H₉), H₂C═CH—(CH₂)₄Si(CH₃)₂(t-C₄H₉), H₂C═CH—(CH₂)₈Si(CH₃)₂(t-C₄H₉), H₂C═CH—CH₂Si(C₂H₅)₃, H₂C═CH—(CH₂)₂Si(C₂H₅)₃, H₂C═CH—(CH₂)₃Si(C₂H₅)₃, H₂C═CH—(CH₂)₄Si(C₂H₅)₃, H₂C═CH—(CH₂)₈Si(C₂H₅)₃, H₂C═CH—CH₂Si(CH₃)₂(n-C₁₈H₃₇), H₂C═CH—(CH₂)₂Si(CH₃)₂(n-C₁₈H₃₇), H₂C═CH—(CH₂)₃Si(CH₃)₂(n-C₁₈H₃₇), H₂C═CH—(CH₂)₄Si(CH₃)₂(n-C₁₈H₃₇), H₂C═CH—(CH₂)₈Si(CH₃)₂(n-C₁₈H₃₇), H₂C═CH—CH₂Si(CH₃)₂(C₆H₅), H₂C═CH—(CH₂)₂Si(CH₃)₂(C₆H₅), H₂C═CH—(CH₂)₃—Si(CH₃)₂(C₆H₅), H₂C═CH—(CH₂)₄Si(CH₃)₂(C₆H₅), H₂C═CH—(CH₂)₈Si(CH₃)₂(C₆H₅), H₂C═CH—CH₂—O—Si(CH₃)₃, H₂C═CH—CH₂—O—Si(C₂H₅)₃, H₂C═CH—CH₂—O—Si(i-C₃H₇)₃, H₂C═CH—CH₂—O—Si(CH₃)₂(t-C₄H₉), H₂C═CH—CH₂—O—Si(CH₃)₂(n-C₁₈H₃₇), H₂C═CH—CH₂—O—Si(CH₃)₂(C₆H₅), H₂C═CH—CH₂Si(CH₃)₂—O—Si(CH₃)₃, H₂C═CH—(CH₂)₂Si(CH₃)₂—O—Si(CH₃)₃, H₂C═CH—(CH₂)₃Si(CH₃)₂—O—Si(CH₃)₃H₂C═CH—(CH₂)₄Si(CH₃)₂—O—Si(CH₃)₃, H₂C═CH—(CH₂)₈Si(CH₃)₂—O—Si(CH₃)₃, H₂C═CH—CH₂Si(CH₃)(—O—Si(CH₃)₃)₂, H₂C═CH—(CH₂)₂Si(CH₃)(—O—Si(CH₃)₃)₂, H₂C═CH—(CH₂)₃Si(CH₃)(—O—Si(CH₃)₃)₂, H₂C═CH—(CH₂)₄Si(CH₃)(—O—Si(CH₃)₃)₂, H₂C═CH—(CH₂)₈Si(CH₃)(—O—Si(CH₃)₃)₂, H₂C═CH—CH₂Si(—O—Si(CH₃)₃)₃, H₂C═CH—(CH₂)₂Si(—O—Si(CH₃)₃)₃, H₂C═CH—(CH₂)₃Si(—O—Si(CH₃)₃)₃, H₂C═CH—(CH₂)₄Si(—O—Si(CH₃)₃)₃, H₂C═CH—(CH₂)₈Si(—O—Si(CH₃)₃)₃, H₂C═CH—CH₂Si(OCH₃)₃, H₂C═CH—(CH₂)₂Si(OCH₃)₃, H₂C═CH—(CH₂)₃Si(OCH₃)₃, H₂C═CH—(CH₂)₄Si(OCH₃)₃, H₂C═CH—(CH₂)₈Si(OCH₃)₃, H₂C═CH—CH₂Si(OC₂H₅)₃, H₂C═CH—(CH₂)₂Si(OC₂H₅)₃, H₂C═CH—(CH₂)₃Si(OC₂H₅)₃, H₂C═CH—(CH₂)₄Si(OC₂H₅)₃, H₂C═CH—(CH₂)₈Si(OC₂H₅)₃, H₂C═CH—CH₂Si(C₆H₅)₃ CAS: [18752-21-1], H₂C═CH—(CH₂)₂Si(C₆H₅)₃, H₂C═CH—(CH₂)₃Si(C₆H₅)₃, H₂C═CH—(CH₂)₄Si(C₆H₅)₃, H₂C═CH—(CH₂)₈Si(C₆H₅)₃, H₂C═C(CH₃)—CH₂Si(CH₃)₃ CAS: [18292-38-1], H₂C═CH—CH₂Si(p-C₆H₄OCH₃) CAS: [68469-60-3], H₂C═CH—CH₂Si(CH₃)₂H, H₂C═CH—(CH₂)₂Si(CH₃)₂H, H₂C═CH—(CH₂)₃Si(CH₃)₂H, H₂C═CH—(CH₂)₄Si(CH₃)₂H, H₂C═CH—(CH₂)₈Si(CH₃)₂H, and mixtures thereof.

Allylsilanes, in particular monofunctional and/or multifunctional allylsilanes, are organofunctional silicon compounds that do not contain Si—O—Si fragments and are therefore not siloxanes. The compositions preferably do not contain any monofunctional allylsilanes. Alternatively, the compositions may be free of di-, tri- or tetrafunctional allylsilanes or free of di-, tri- and tetrafunctional allylsilanes.

A composition is considered to contain essentially no monounsaturated compound, preferably no unsaturated compound of formula I, and/or no allylsilanes if it consists of less than 0.035 wt.-% of a monounsaturated compound, in particular one or more compounds of formula I and/or no allylsilanes in a total composition of the curable composition with 100 wt.-%, preferably less than or equal to 0.025 wt.-%, more preferably less than 0.001 wt.-%. Alternatively, a composition containing a base component and/or catalyst component, each independently containing less than or equal to 0.025 wt.-%, preferably less than or equal to 0.001 wt.-%, with respect to the respective total composition of 100 wt.-%, is considered to contain essentially no unsaturated compound, in particular of formula I. Preferred simple unsaturated compounds of formula I which are not contained in the composition have a molecular weight of less than 500 g/mol, preferably less than 250 g/mol.

Furthermore, a preferred composition may not comprise any tetraallylsilane. Preferably, a composition may not comprise any tetraallylsilane or may comprise a maximum of 0.001 to 0.25 wt.-%, in particular 0.001 to 0.15 wt.-%, preferably 0.001 to 0.1 wt.-%, tetraallyl silane with respect to the total composition of the curable composition of 100 wt.-%. In a particularly preferred alternative, the curable composition does not comprise tetraallylsilane. It has been found that a certain amount of tetraallylsilane can be added to the composition to advantageously prolong the processing time, in particular without adversely affecting the additive curing in the time window t₉₀−t₅, so that, overall, a good processing time of less than 2 minutes and subsequent rapid curing of less than 1 minute can be achieved.

The significant advantage of the invention is thus that, due to the ratio according to the invention of polysiloxanes comprising at least two terminal ethylene groups and polysiloxanes comprising at least two Si—H groups, very fast additive curing can be achieved within a time window, wherein the time window can be adjusted to longer processing times by adding tetraallylsilane and the fast curing is maintained, so that the total time from mixing to reaching 90% of the complex viscosity at 30° C. can be less than 3 minutes.

Furthermore, it is particularly preferred if a composition comprises at least one surfactant comprising a polyether, polyether-functionalized siloxanol oligomer, fatty alcohol and/or fluorosurfactant or mixtures of the aforementioned surfactants. Preferred surfactants may optionally comprise at least one nonionic or ionic fluorinated surfactant comprising at least one fluoroalkyl group. A composition particularly preferred comprises at least one surfactant comprising a polyether and/or at least one polyether-functionalized siloxane oligomer or mixtures of the aforementioned surfactants. Preferred surfactants comprise polyether-functional siloxane surfactants and optionally a polyether, such as allyloxypolyethylene glycol alkyl ether, preferably allyloxypolyethylene glycol methyl ether, for adjusting the hydrophilicity of the composition. Preferred surfactants comprise polyether-functionalized siloxane oligomers with at least one alkylsiloxane group and optionally a polyether. The further surfactant particularly preferably comprises at least one polyether alkylene-functionalized siloxane oligomer with at least one alkylsiloxane group. By definition, surfactants do not contain SiH and/or ethylene groups.

Surfactants are usually added to addition-curing impression materials in particular to achieve increased hydrophilicity and thus facilitate flow onto moist surfaces. In addition to classic nonionic surfactants, partially fluorinated and/or perfluorinated surfactants, sometimes in combination with classic surfactants, are also used in dental impression materials.

The content of surfactant(s) in the composition can range from 0.1 to 10 wt.-%, preferably from 0.1 to 7.5 wt.-%, particularly preferably from 0.1 to 5 wt.-%, and more preferably from 1 to 3 wt.-%, with the total composition of the curable composition being 100 wt.-%.

The invention also relates to a composition comprising addition-crosslinking polysiloxanes containing at least two terminal ethylene groups with a content of ethylene groups of 0.01 mmol/g to 10 mmol/g ethylene groups, in particular vinyl groups. In particular, the polysiloxanes containing at least two terminal ethylene groups comprise a mixture of polysiloxanes (EP1) containing terminal ethylene groups of 0.01 to 0.07 mmol/g vinyl groups and polysiloxanes (EP2) containing terminal ethylene groups of 0.1 to 0.5 mmol/g vinyl groups. (EP2) of 0.1 to 0.5 mmol/g vinyl groups. Preferably, the polysiloxanes containing terminal ethylene groups (EP1) comprise polysiloxanes with a vinyl group content of 0.01 to 0.07 mmol/g and a viscosity of 100 mPas to 2000 mPas (viscosity determination method: DIN 53015 Höppler, vinyl group content with FTIR spectroscopy using a calibration curve) and the polysiloxanes containing terminal ethylene groups (EP2) with a vinyl group content of 0.1 to 0.5 mmol/g have a viscosity of 5000 to 20000 mPas. The weight ratio of EP1 to EP2 is preferably in the range of 10:1 to 1:10, preferably 5:1 to 1:2. It is further preferred that in the base component, the weight ratio of EP1:EP2 is 5:1 to 2:1 and/or in the catalyst component the weight ratio of EP1:EP2 is 2:1 to 1:10, preferably 1.5:1 to 1:2.

According to a particularly preferred embodiment, a curable composition comprises a first polysiloxane composition (PS1) with a Si—H group content of 1 to 3.0 mmol/g, preferably a Si—H group content of 1.3 to 2.5 mmol/g, preferably a Si—H group content of 1.4 to 2.5 mmol/g. Likewise, a preferred composition may comprise, preferably simultaneously, a second polysiloxane composition (PS2) with a Si—H group content of 3.9 mmol/g to 10 mmol/g, preferably a Si—H group content of 4.0 to 5.0 mmol/g, in particular 4.1 to 5.0 mmol/g, alternatively preferably a Si—H group content of 4.0 to 8.0 mmol/g, in particular 4.1 to 8.0 mmol/g.

Furthermore, it is particularly preferred if, in the curable composition, the molar ratio of Si—H groups of the polysiloxanes to ethylene groups of the polysiloxanes is from 3.5:1 to 10:1, in particular from 6:1 to 10:1.

Particularly preferred is the curable composition or a mixture of base component and catalyst component, especially in a ratio of 5:1 to 1:5, preferably from 1:1 to 2:1 to 1:2, particularly preferred from 1:1, a molar ratio of Si—H groups of the polysiloxanes to ethylene groups of the polysiloxanes of 1:1.8 to 1:6 with a first polysiloxane composition (PS1) with a content of Si—H groups of 1.3 to 2.5 mmol/g and a second polysiloxane composition (PS2) having a Si—H group content of 4 mmol/g to 8 mmol/g, and optionally wherein the ratio of terminal ethylene groups of the base component to terminal ethylene groups in the catalyst component is in a molar ratio of 1:1.1 to 1:10, preferably the molar ratio is 1:1.2 to 1:10, particularly preferred from 1:1.3 to 1:10, and further preferred from 1:1.4 to 1:2.

According to a preferred embodiment, the first and second polysiloxane compositions are present in the composition as a mixture, and wherein the first polysiloxane composition (PS1) and the second polysiloxane composition (PS2) are present in a weight ratio of 1:1.6 to 1:10, or of 1:3 to 1:10, in particular in a weight ratio of 1:4 to 1:6. Furthermore, it is preferred that PS1 and PS2 are present in a weight ratio of 1:1.7 to 1:10, in particular in a weight ratio of 1:1.7 to 1:6, preferably from 1:1.8 to 1:2.3. According to a particularly preferred embodiment, the first and second polysiloxane compositions are present as a mixture, wherein the first polysiloxane composition (PS1) and the second polysiloxane composition (PS2) are present in a weight ratio of 1:1.5 to 1:2.2, in particular in a weight ratio of 1:1.5 to 1:2.

According to a further preferred embodiment, the curable composition is obtainable, is produced or is obtained by mixing two components to obtain an addition-curing curable composition, wherein the two components comprise, in particular are selected from:
a) base components comprising addition-crosslinkable polysiloxanes containing at least two terminal ethylene groups and polydialkylsiloxanes containing at least two Si—H groups, in particular polydialkylsiloxanes containing at least two terminal ethylene groups and polydialkylsiloxanes containing at least two Si—H groups, and
b) a catalyst component comprising a hydrosilylation catalyst comprising platinum, rhodium and/or palladium and optionally comprising
addition-crosslinking polysiloxanes comprising terminal ethylene groups and optionally polysiloxanes comprising Si—H groups, in particular polydialkylsiloxanes containing terminal ethylene groups, and optionally,
wherein the base component and/or the catalyst component can each independently comprise
   optionally inorganic fillers, organic particulate polymers, in particular
a particle size of 10 nm to 75 micrometers, and
   optionally pigments comprising organic or inorganic pigments.

In each case, it is preferred that the base component and/or the catalyst component independently contain at least one nonionic or ionic, at least one polyether and/or a polyether-functionalized siloxane oligomer and optionally one or mixtures of the aforementioned surfactants.

According to an alternative embodiment, a curable composition comprises addition-crosslinkable organofunctional polysiloxanes comprising, in particular selected from
i. addition-crosslinkable polysiloxanes comprising at least two terminal ethylene groups, in particular polysiloxanes comprising from 0.01 to 10 mmol/g of terminal ethylene groups, preferably from 0.025 mmol/g to 5 mmol/g, particularly preferred from 0.025 mmol/g to 1 mmol/g, and
ii. at least two polysiloxanes comprising Si—H groups, in particular polyhydrogensiloxane, wherein the polysiloxanes comprising Si—H groups comprise at least two polysiloxane compositions with different contents of Si—H groups, wherein a first polysiloxane composition (PS1) has a content of Si—H groups of 1 to 3.0 mmol/g and a second polysiloxane composition (PS2) has a Si—H group content of 3.9 mmol/g to 15 mmol/g, in particular the first and second and optionally further polysiloxane compositions are present as a mixture, wherein the first polysiloxane composition (PS1) having a Si—H group content and the second polysiloxane composition (PS2) having a Si—H group content in a weight ratio of 1:1.8 to 1:6, and wherein the molar ratio of Si—H groups of the polysiloxanes to ethylene groups of the polysiloxanes is from 4:1 to 10:1.

Furthermore, a composition is preferred in which the polydialkylsiloxanes comprising at least two terminal ethylene groups can be selected from vinyl-terminated polydialkylsiloxanes and vinyl-terminated polyether-functional polydialkylsiloxanes, and/or the polydialkylsiloxanes comprising at least two Si—H groups can be selected from polydialkylsiloxanes and polyether-functional polydialkylsiloxanes, wherein these terminal Si—H groups and optionally the polysiloxane backbone may contain —Si(CH₃)H groups.

Preferred polysiloxanes comprise polydialkylsiloxanes with alkyl each independently having 1 to 16 carbon atoms, in particular methyl groups.

According to a further preferred embodiment, the vinyl-terminated polydialkylsiloxanes and vinyl-terminated polyether-functional polydialkylsiloxanes can be selected from vinyl-terminated polydimethylsiloxanes and vinyl-terminated polyether-functional polydimethyl-siloxanes. The polydialkylsiloxanes comprising Si—H groups may preferably be selected from polydimethylsiloxanes and polyether-functional polydimethylsiloxanes which comprise terminal Si—H groups and optionally —Si(CH₃)H groups in the polysiloxane backbone.

Furthermore, the vinyl-terminated polysiloxanes preferably comprise vinyl-terminated polydialkylsiloxanes and vinyl-terminated polyether-functional polydialkylsiloxanes with a mean molecular weight (mass average, weight average) Mw in the range from 31,000 g/mol to 124,000 g/mol, preferably the number average Mn is in the range from 22,000 g/mol to 89,000 g/mol. It is also preferred that the polydialkylsiloxanes containing Si—H groups are selected from polydimethylsiloxanes and polyether-functional polydimethylsiloxanes, each independently having terminal Si—H groups and optionally having —Si(CH₃)H groups in polysiloxane-backbone, in particular with a mean molecular weight (mass average, weight average) Mw in the range from 500 g/mol to 19,000 g/mol, and preferably the number average Mn is in the range from 500 g/mol to 14,000 g/mol.

The polydialkylsiloxanes comprising at least two Si—H groups are preferably selected from polydialkylsiloxanes and polyether-functional polydialkylsiloxanes which comprise terminal Si—H groups and optionally —Si(CH₃)H groups in the polysiloxane backbone, and with a content of Si—H and optionally in the polysiloxane backbone —Si(CH₃)H groups of 4 to 8 mmol/g, in particular of 4.05 mmol/g to 8 mmol/g. It may also be preferred that the polydialkylsiloxanes containing Si—H groups are selected from polydialkylsiloxanes and polyether-functional polydialkylsiloxanes, each independently with terminal Si—H groups and optionally —Si(CH₃)H groups in the polysiloxane backbone, which have a viscosity of 10 to 500 mPa·s.

The polydialkylsiloxanes containing terminal ethylene groups may be preferably selected from vinyl-terminated polydialkylsiloxanes and vinyl-terminated polyether-functional polydialkylsiloxanes, with a vinyl group content in the range from 0.02 mmol/g to 2.0 mmol/g, preferably from 0.02 to 1.0 mmol/g.

According to an alternative embodiment, a composition is preferred which is obtainable or is obtained by mixing a
i) base component and
ii) catalyst component, wherein
i) the base component comprises
30 to 50 wt.-%, in particular 35 to 45 wt.-%, of polydialkylsiloxanes comprising at least two terminal ethylene groups,
15 to 64 wt.-%, in particular 30 to 50 wt.-%, of inorganic fillers,
5 to 30 wt.-%, in particular 7 to 25 wt.-%, of polydialkylsiloxanes comprising at least two Si—H groups,
1.0 to 15 wt.-%, in particular 1 to 10 wt.-%, at least one surfactant, in particular at least one polyether and/or at least one polyether-functionalized siloxane oligomer, in particular the polyether-functionalized siloxane oligomer has at least one alkylsiloxane group, or mixtures of these surfactants, and
wherein the total amount of the base component is 100 wt.-%, and
ii) the catalyst component comprises
20 to 80 wt.-%, in particular 35 to 65 wt.-%, of polydialkylsiloxanes comprising at least two terminal ethylene groups,
5 to 70 wt.-%, in particular 35 to 65 wt.-%, inorganic fillers,
0.001 to 5.0 wt.-% of a hydrosilylation catalyst comprising platinum, rhodium or palladium,
0 to 15 wt.-% of at least one surfactant, in particular 1.0 to 15 wt.-% of at least one surfactant, in particular at least one polyether and/or at least one polyether-functionalized siloxane oligomer, in particular the polyether-functionalized siloxane oligomer has at least one alkylsiloxane group, or mixtures of these surfactants, and
0 to 10 wt.-% organic or inorganic pigments and/or structuring agents, the total amount of catalyst components being 100 wt.-%.

According to a preferred alternative, the base components and the catalyst component are mixed in a weight ratio of 10:1 to 1:10, in particular in a ratio of 5:1 to 1:5, preferably of 2:1 to 1:2.

Furthermore, it is preferred that the composition is obtainable or is obtained by mixing i) a base component and ii) a catalyst component, wherein
i) the base component comprises 30 to 50 wt.-% of polydialkylsiloxanes comprising at least two terminal ethylene groups, and
ii) the catalyst component comprises 20 to 80 wt.-% of polydialkylsiloxanes containing at least two terminal ethylene groups, and wherein the ratio of terminal ethylene groups of the base component to terminal ethylene groups of the catalyst component is in a molar ratio of 1:1.1 to 1:10, preferably the molar ratio is 1:1.2 to 1:10, particularly preferably 1:1.3 to 1:10, and more preferably 1:1.4 to 1:2.

Preferred curable compositions comprise i) a base component and a
ii) catalyst component or are optionally obtainable by mixing an
i) base component and ii) catalyst component, wherein i) comprising
30 to 50 wt.-%, in particular 20 to 39 wt.-%, of polydialkylsiloxanes comprising terminal ethylene groups,
15 to 64 wt.-%, in particular 36 to 63 wt.-%, of inorganic fillers,
5 to 30 wt.-%, in particular 5 to 21 wt.-%, polydialkylsiloxanes comprising Si—H groups,
1.0 to 15 wt.-%, in particular 1 to 10 wt.-%, at least surfactant and optionally at least one further surfactant comprising at least one polyether and/or at least one polyether-functionalized siloxane oligomer, particularly preferred from 4 to 8 wt.-%, at least one polyether and/or at least one polyether-functionalized siloxane oligomer, in particular the polyether-functionalized siloxane oligomer has at least one alkylsiloxane group, or mixtures of these surfactants, the preferred further surfactant is at least one polyether-functionalized siloxane oligomer, and 0 to 10 wt.-%, in particular 0.001 to 0.5 wt.-%, of a palladium-comprising composition, and 0 to 10 wt.-% organic or inorganic pigments and/or structuring agents,
where the total sum of the components in the base component is 100 wt.-%, and
ii) comprising 20 to 80 wt.-%, in particular 30 to 80 wt.-%, polydialkylsiloxanes comprising at least two terminal ethylene groups, particularly preferably 36 to 61 wt.-%,
5 to 70 wt.-%, in particular 36 to 61 wt.-%, inorganic fillers,
0.001 to 5.0 wt.-%, in particular 0.2 to 1.0 wt.-%, of a hydrosilylation catalyst comprising platinum, rhodium or palladium, in particular a hydrosilylation catalyst comprising platinum, preferably a Karstedt catalyst,
1.0 to 15 wt.-%, in particular 1 to 10 wt.-%, of at least one surfactant and optionally at least one further surfactant comprising at least one polyether and/or at least one polyether-functionalized siloxane oligomer, in particular the polyether-functionalized siloxane oligomer has at least one alkylsiloxane group, or mixtures of these surfactants, preferably the further surfactant is at least one polyether-functionalized siloxane oligomer,
0 to 10 wt.-% organic or inorganic pigments and/or structuring agents, the total amount of the components in the catalyst component being 100 wt.-%,
wherein the total content of the at least one surfactant and optionally the at least one further surfactant comprises at least one polyether and/or at least one polyether-functionalized siloxanol oligomer or a mixture of the aforementioned surfactants in a composition of 2.0 to 20 wt.-%.

According to a further embodiment, the invention relates to a kit comprising a 2K dispensing device comprising at least two cartridges, wherein the i) base component is present in one cartridge and the ii) catalyst components are present in the second cartridge. The kit may further comprise at least one removable and attachable static mixer.

Preferably, the at least one further surfactant is selected from polyether and polyether-functionalized siloxanol oligomers, wherein the siloxanol oligomer contains at least one alkylsiloxane group, in particular the polyethers and/or the polyether groups of the polyether-functionalized siloxane oligomers are selected from polyalkylene oxide groups, in particular the polyalkylene oxide groups are selected from polyethylene oxide groups comprising methoxypolyethylene oxide alkylene groups, ethoxy polyethylene oxide alkylene groups, methoxy ethylene oxide alkylene groups, polyethylene oxide alkylene groups.

The at least one further surfactant is further preferred to comprise or be selected from polyethers and polyether-functionalized siloxanol oligomers, wherein the siloxanol oligomer contains at least one alkyl trisiloxane group, preferably a polyalkylene oxide-functionalized heptamethyltrisiloxane, preferably a polyethylene oxide alkylene-functionalized heptamethyltrisiloxane, particularly preferred is 3-(2-methoxyethoxy)propyl-methyl-bis(trimethylsilyoxy)silane.

The surfactant is particularly preferably selected from polyethers and polyether-functionalized siloxanol oligomers, wherein the siloxanol oligomer contains at least one alkylsiloxane group, in particular the polyethers and/or the polyether groups of the polyether-functionalized siloxanol oligomers are selected from polyalkylene oxides.

Preferred are the polyalkylene oxide groups of the polyether-functionalized siloxane oligomers selected from polyethylene oxide groups, methoxy-polyethylene oxide-alkylene groups, ethoxy-polyethylene oxide-alkylene groups, methoxy-ethoxy-alkylene groups, polyethylene oxide alkylene groups, a polyalkylene oxide-functionalized alkyl trisiloxane is preferred, preferably a polyalkylene oxide-functionalized heptamethyl trisiloxane, and polyalkylene oxide alkylene-functionalized heptamethyl trisiloxane is particularly preferred. The viscosity of the further surfactant is preferably between 15 and 24.1 mPas. Preferred further surfactants include: 3-(2-methoxyethoxy)propyl-methyl-bis(trimethylsilyoxy)silane.

Polyether comprises α- and/or ω-polyether of alkenyl polyethers, alkynyl polyethers, hydroxy polyethers, aryloxy-, arylalkyloxy- and/or alkoxy-terminated polyethers. Preferred polyethers comprise α-alkenylene-ω-alkyl polyethers with C1 to C8 alkenylene and C1 to C4 alkyl, preferably allyl polyethylene glycol methyl ether (CAS 27252-80-8) and/or α,ω-alkyl polyethers with C₁ to C₄ alkyl. The additional surfactant may preferably be present as a mixture of polyethers and polyether-functionalized siloxane oligomers.

Polyether according to the present invention may comprise C2 to C4 alkylene oxides as surfactant or polyether-functional polydialkylsiloxanes containing terminal ethylene groups.

The polyether-functional polydialkylsiloxanes containing terminal ethylene groups are preferably selected from vinyl-terminated polyether-functional polydialkylsiloxanes comprising C2 to C4 alkylene oxides. Suitable polyols for the preparation of the polyethers are, for example, the reaction products of ethylene glycol, propylene glycol, butanediol or hexanediol isomers with one or more of the following alkylene oxides: ethylene oxide, propylene oxide or butylene oxides, such as tetrahydrofuran. Furthermore, polyethers can also be reaction products of polyfunctional alcohols such as glycerin, trimethylolethane or trimethylolpropane, pentaerythritol or sugar alcohols or mixtures of two or more thereof with the aforementioned alkylene oxides, which are suitable for forming the polyether polyols.

Suitable hydrosilylation catalysts comprising platinum, rhodium or palladium are understood to be catalysts comprising platinum, rhodium or palladium or their precatalysts, which can be dissolved in the siloxanes and preferably in the components. Catalysts which do not form a disperse phase in the other compounds present in the components are therefore preferred. Preferred are platinum complexes comprising ethylenic siloxane compounds, preferably divinyl disiloxanes. Typical precatalysts are hexachloroplatinic acid dissolved in isopropanol (Speier catalyst) and Karstedt catalysts (H₂ PtCl₆ and divinyldisiloxanes such as (CH₂═CH)Me₂Si—O—SiMe₂ (CH═CH₂)). Karstedt catalysts may contain dinuclear platinum(0) complexes. Similarly preferred hydrosilylation catalysts comprise [1,3-bis(cyclohexyl)imidazol-2-ylidene][1,3-divinyl-1,1,3,3-tetramethyldisiloxane]-platinum(0)(ICy)Pt(vs); [1,3-bis(2,6-diisopropylphenyl)imidazol-2-ylidene][1,3-divinyl-1,1,3,3-tetramethyldisiloxane]-platinum(0), (IPr)Pt(vs).

Alternatively, the polydimethylsiloxanes may have 1 to 10 mol % of the methyl groups in the siloxane backbone substituted by alkyl groups with C2 to C16, in particular C2 to C8, and/or phenyl groups. Alternatively, allyl-terminated polydialkylsiloxanes or allyl-terminated polyether-functional polydialkylsiloxanes can also be used.

Furthermore, compositions are preferred in which the vinyl-terminated polydialkylsiloxanes and vinyl-terminated polyether-functional polydialkylsiloxanes have a mean molecular weight (mass average, weight average) Mw in the range from 31,000 g/mol to 124,000 g/mol, preferably the number average Mn is in the range from 22,000 g/mol to 89,000 g/mol, and/or the polydialkylsiloxanes containing Si—H groups are preferably selected from polydimethylsiloxanes and polyether-functional polydimethylsiloxanes with terminal Si—H groups and optionally with groups containing —Si(CH₃)H— in the polysiloxane backbone, in particular with a mean molecular weight (mass average, weight average) Mw in the range of 500 g/mol to 19,000 g/mol, and preferably the number average Mn is in the range from 500 g/mol to 14,000 g/mol. Mw and Mn can be determined by gel permeation chromatography (SDB copolymer with toluene eluent).

Compositions comprising polydialkylsiloxanes containing terminal ethylene groups, which are selected from vinyl-terminated polydialkylsiloxanes and vinyl-terminated polyether-functional polydialkylsiloxanes having a viscosity of 100 to 100,000 mPa·s, and/or in which the polydialkylsiloxanes containing Si—H groups are selected from polydialkylsiloxanes and polyether-functional polydialkylsiloxanes which contain terminal Si—H groups and optionally in the polysiloxane backbone —Si(CH₃)H groups and have a viscosity of 10 to 500 mPa·s, in particular from 20 to 50 mPa·s (DIN 53015 Höppler ball 3) and optionally from 200 to 340 mPa·s (DIN 53015 Höppler ball 4). The viscosity is generally determined using (DIN 53015 Höppler), whereby for polydialkylsiloxanes comprising ethylene groups, the viscosity can be determined using rotational viscosity cone (4°/40 mm)/plate BU-Q 30.027) U0.2/U1: DIN 53015 Höppler ball 5.

Likewise, curable compositions, base and/or catalyst components comprising polydialkylsiloxanes containing Si—H groups of a first polysiloxane composition (PS1) are preferred, which comprise the terminal Si—H groups and optionally containing —Si(CH₃)H groups in the polysiloxane backbone, the content of Si—H and optionally —Si(CH₃)H groups in the polysiloxane backbone being 1 to 3.5 mmol/g, preferably 1 to 2 mmol/g. Also preferred are polydialkylsiloxanes comprising Si—H groups as the base- e and/or catalyst component of a second polysiloxane composition (PS2), which comprise the terminal Si—H groups and optionally —Si(CH₃)H groups in the polysiloxane backbone, wherein the content of Si—H and optionally in the —Si(CH₃)H groups in the polysiloxane backbone is from 3.8 to 15 mmol/g, preferably the content is from 4 to 8, in particular 4.05 to 8 mmol/g.

Structural agents such as rheology modifiers, e.g. aerosols or the like, may be used. Palladium-containing compounds may be added to the curable compounds as hydrogen scavengers. Silicon dioxide, pyrogenic silica, precipitated silica, quartz, and kaolin may be used as inorganic fillers or organic particulate polymers, whereby the inorganic fillers are preferably hydrophobic. Other surfactants that may be used include fatty alcohols, such as ethoxylated fatty alcohols, in particular C11 to C14 alcohols.

According to a preferred embodiment, the base component and the catalyst component may be mixed in a weight ratio of about 1:1 to 10:1, preferably about 1:1 or about 5:1 or about 4:1 or about 10:1. Particularly preferred are weight ratios of 2:1 to 1:2, and more preferred ratios of 1:1 with a deviation of +/−15 wt.-%.

The invention also relates to the use of the composition for making impressions in the medical, dental, and/or veterinary fields, for making impressions in the field of botany, for making impressions in the marine and aquatic fields, for making impressions of the surfaces of articles, for making impressions of designs, art or handicraft objects, as a dental impression material, as an impression material for human, veterinary or marine soft (tissue) and/or hard structures (bones, shells, coral), such as ear impressions, podiatry, forensic technology, for making impressions of electronic components, for making impressions of objects whose surfaces are wetted with aqueous compositions or whose surfaces are wetted with water, and/or for printing three-dimensional structures, particularly in the semiconductor field.

The compositions according to the invention are suitable as molding materials in which a high level of detail must be achieved. Molding material, in particular dental molding material, comprising precision impression materials, situation impression materials, bite registration materials, duplication materials (applicable for the duplication of master models, such as all-ceramic restorations, inlays, onlays, cantilevers, as well as modeling materials, such as those used for gum reconstruction.

The following examples are provided to illustrate the invention without limiting it to the specific examples.

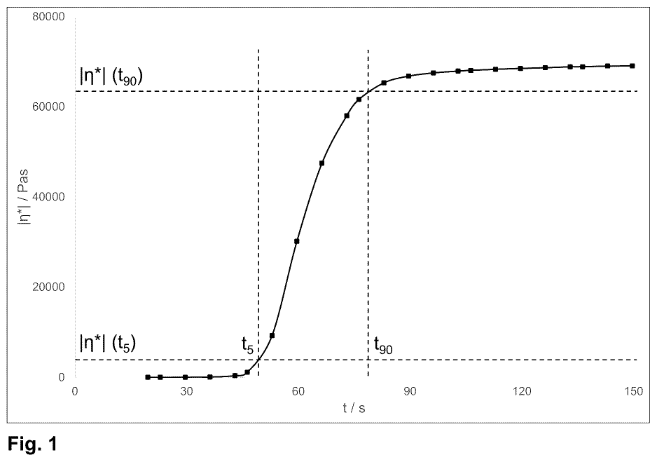

FIG. 1 shows: Complex viscosity (η*(t₅), η*(t₉₀) over 10 minutes for modified reference example 1, HAAKE RheoStress 1, rotational rheometer, oscillation mode, 30° C.

The base pastes (base component) and catalyst paste (catalyst component) were homogenized separately in a planetary mixer. For the subsequent tests, 60 g batches comprising the respective paste were prepared in a Hauschild beaker. The base paste and catalyst paste prepared in this way were then filled into cartridges. In the following examples, the base paste and catalyst paste were mixed in a weight ratio of 1:1 using static mixers.

### Viscosity Measurements

In accordance with FIG. 1, the complex viscosity was measured on a HAAKE™ RheoStress™ 1 rotational rheometer, oscillation mode, at 30° C. and represented as |η*| [Pas] vs t [min]. Continuous increase of the shear rate to 8 Hz, followed by a reduction of the shear rate, and the viscosity is measured at 3 Hz. The complex viscosity after 10 min corresponds to the maximum value, t₉₀ corresponds to the time at 90% of this value, and t₅ corresponds to the time at 5% of the maximum value.

Procedure: The complex viscosity during curing is measured using a rheometer at 30° C. The material is cured on the oscillation rheometer for 10 minutes. The final viscosity is read after 10 minutes and used to calculate the values t₅ (time at 5% of the final viscosity) and t₉₀ (time at 90% of the final viscosity). The times are obtained by extrapolating the curves at the corresponding viscosity value.

### Measurement Conditions for Viscosity Measurement

| Device | RheoStress 1 | |
|---|---|---|
| Manufacturer | Thermo Scientific | |
| Measuring device | Plate/plate, profiled | |
| Measurement | P20 TiL S | |
| geometry | | |
| Measuring plate | MPC20 S | |
| attachment | | |
| Type Rotary body | PP20PRO. | |
| Measuring temperature | 30° | C. |
| Measuring frequency | 1.0 | Hz |
| Shear stress | 800 | Pa |
| Split height | 0.5 | mm |
| Gap volume | 0.2 | ml |

| | |
|---|---|
| Rotation mode | CS |
| Measurement type | Oscillation |
| Measurement duration | No change in viscosity curve visible = |
| | termination, or max. 10 min |

The sample quantity was as follows: m=(1.0±0.1) g

The difference between t₉₀−t₅ in minutes (industrial time) indicates the transition time (defined time window of the hardening reaction) from the plastic to the elastic state. The shorter t₉₀−t₅ is, the faster the composition hardens within this time window.

TABLE 1
Defined time window for curing reaction t = (t₉₀ − t₅) (min), Δ T (° C.)

| | | | Modified | |
|---|---|---|---|---|
| | | | reference | |
| | | | example 1 | |
| | | | 3 wt.-% | Modified |
| | | | allyltri- | reference |
| | | | methylsilane | example 2 |
| | | | 0.5 wt.-% | (WO2013/025494) |
| | Example | Example | tetraallylsilane | Example 1 |
| | 1 | 7 | in catalyst paste | B/A |
| t₅ (min) | 1.25 | 1.45 | 0.96 | 1.83 |
| t = (t₉₀ − t₅) (min) | 0.33 | 0.5 | 0.76 | 0.94 |
| ΔT (° C.) | 2.8 | 2.8 | 10.1 | 11.7 |

### Temperature Measurement:

### Description of the Method

1. A tube (21 mm diameter laminate tube=plastic-coated aluminum tube) is cut to a length of approximately 5 cm.
2. The tube is filled with material using a static mixer (1:1 system, 5:1 with dynamic mixer) until it contains approximately 8 g of material. The time is started when the material is first dispensed from the cartridge. The quantities were weighed after the test.
3. The temperature sensor of the measuring device (type: Testo 925) is placed in the mass. After 15 seconds, the first measurement is recorded.
4. From 30 seconds onwards, the temperature is recorded every 30 seconds for 10 minutes. At this point, all samples had already passed their maximum temperature and the temperature was steadily decreasing.
5. The sample is removed from the temperature measuring device and weighed (m=8 g+/−0.5 g).

### Mixture of Polydimethylsiloxane (PDMS Oil)

Polydimethylsiloxane with terminal vinyl groups (vinyl content: 0.13 mmol/g)
Polydimethylsiloxane with terminal vinyl groups
(vinyl content: 0.05 mmol/g)

The vinyl content in the base pastes of the following examples is:
C═C group content: (0.066 to 0.076) mmol/g. The C═C group content increases from Example 1 to Example 7.

### Polydimethylsiloxane (PDMS Oil) Mixture:

The vinyl content in the catalyst pastes of the following examples is:
C═C group content: 0.088 mmol/g

Comparative examples (modified reference examples): In the examples of WO2013/025494, Example 1, B/A, no information on the vinyl content or C═C content is disclosed, therefore the vinyl content was adjusted analogously to the above base and catalyst pastes.
Crosslinking agent: Poly(methyl)(hydrogen)siloxane
crystalline SiO₂: cristobalite
Palladium dispersion (Pd dispersion): Palladium chloride dispersion in divinyl poly-dimethylsiloxane
Catalyst: Platinum tetramethyldivinyldisiloxane complex, Karstedt catalyst Preparation (4 wt.-% Pt)

The mixing ratio of base paste and catalyst paste for the impression materials is 1:1, unless otherwise specified. Therefore, the examples given as reference examples are not comparative examples according to the state of the art, but internal reference examples.

TABLE 2

Example 1

| | Base | Catalyst |
|---|---|---|
| | [wt.-%] | [wt.-%] |
| PDMS oil mixture | 40 | 49.1 |
| Crosslinker PS1 (1.8 mmol/g | 6.4 | — |
| SiH) | | |
| Crosslinker PS2 (4.17 mmol/g | 11.6 | — |
| SiH) | | |

| | |
|---|---|
| n(vinyl) [mmol/wt-%] | 7 |

| | | |
|---|---|---|
| n(SiH) [mmol/wt-%] | 59.9 | |
| Pyrogenic silica | 2.6 | 3.5 |
| Crystalline SiO₂ | 36.3 | 42.4 |
| Silicone polyether surfactant | 3.1 | — |
| Silicone oil (10 mPas) | — | 3.5 |
| Pigment | — | 0.6 |
| Pt catalyst | — | 0.4 |
| Pd dispersion | — | 0.5 |

| | |
|---|---|
| SiH/vinyl: molar ratio | 8.6 |
| t₅ / min | 1.25 |
| (t₉₀ − t₅ ) / min | 0.33 |
| ΔT / ° C. | 2.8 |
| PS1:PS2 weight ratio** | 1:1.81 |

TABLE 3

| | modified reference | | modified | |
|---|---|---|---|---|
| | example 2 | | reference | |
| | WO 2013/025494 | | example | |
| | Example 1, B/A | | 1 | |
| | 3% allyltri- | | 3% allyltri- | |
| | methylsilane | | methylsilane | |
| | in base | | in Kat | |
| | Base | Catalyst | Base | Catalyst |
| | [wt.-%] | [wt.-%] | [wt.-%] | [wt.-%] |
| PDMS mixture Oil | 40.7 | 49.1 | 40 | 49.1 |
| C═C content in | | | | |
| WO 2013/025494 | | | | |
| Not specified* | | | | |
| Crosslinker PS1 | 5.7 | — | 6.4 | — |
| (1.8 mmol/g SiH) | | | | |
| Crosslinker PS2 | 11.6 | — | — | — |
| (4.0 mmol/g SiH) | | | | |
| Crosslinker PS2 | — | — | 11.6 | — |
| (4.17 mmol/g SiH) | | | | |
| n(vinyl) [mmol/wt-%] | 7.1 | | 7.0 | |
| n(SiH) [mmol/wt-%] | 56.7 | | 59.9 | |
| Pyrogenic silica | 2.6 | 3.5 | 2.6 | 3.5 |
| Crystalline SiO₂ | 33.3 | 45.4 | 36.3 | 42.4 |
| Silicopolyether surfactant | 3.1 | — | 3.1 | — |
| Allyltrimethylsilane | 3 | — | — | 3 |
| Silicone oil (10 mPas) | — | — | — | — |
| Pigment | — | 0.6 | — | 0.6 |
| Tetraallylsilane | — | 0.5 | — | 0.5 |
| Pt catalyst | — | 0.4 | — | 0.4 |
| Pd dispersion | — | 0.5 | — | 0 |

| | | |
|---|---|---|
| SiH/vinyl: molar ratio | 8.0 | 8.6 |
| X/Y: molar ratio of SiH groups | 2.16 | 2.28 |
| to C═C groups of the | | |
| compound of formula I | | |
| t₅ / min | 1.83 | 0.96 |
| (t₉₀ − t₅ ) / min | 0.94 | 0.72 |
| ΔT / ° C. | 11.7 | 10.1 |
| PS1:PS2 weight ratio | 1:2.04 | 1:1.81 |

*It was reworked with its own silicone oil content vinyl groups as a comparison example.

TABLE 4

| | Example 2 | | Example 3 | |
|---|---|---|---|---|
| | Base | Catalyst | Base | Catalyst |
| | [wt.-%] | [wt.-%] | [wt.-%] | [wt.-%] |
| PDMS mixture Oil | 39 | 49.1 | 40.5 | 49.1 |
| Crosslinker PS1 | 6.4 | — | 2.5 | — |
| (1.8 mmol/g SiH) | | | | |
| Crosslinker PS2 | 12.6 | — | 15 | — |
| (4.17 mmol/g SiH) | | | | |
| n(vinyl) [mmol/weight %] | 6.9 | | 6.9 | |
| n(SiH) [mmol/wt-%] | 64.1 | | 67.1 | |
| Pyrogenic silica | 2.6 | 3.5 | 2.6 | 3.5 |
| Crystalline SiO₂ | 36.3 | 42.4 | 36.3 | 42.4 |
| Silicopolyester surfactant | 3.1 | — | 3.1 | — |
| Silicone oil (10 mPas) | — | 3.5 | — | 3.5 |
| Pigment | — | 0.6 | — | 0.6 |
| Pt catalyst | — | 0.4 | — | 0.4 |
| Pd dispersion | — | 0.5 | — | 0.5 |

| | | |
|---|---|---|
| SiH/vinyl: molar ratio | 9.3 | 9.7 |
| t₅ / min | 1.32 | 1.34 |
| (t₉₀ − t₅ ) / min | 0.5 | 0.39 |
| ΔT / ° C. | 3.1 | 2.8 |
| PS1:PS2 weight ratio | 1:1.97 | 1:6 |

TABLE 5

| | Example 4 | | Example 5 | |
|---|---|---|---|---|
| | Base | Catalyst | Base | Catalyst |
| | [wt.-%] | [wt.-%] | [wt.-%] | [wt.-%] |
| PDMS mixture Oil | 44 | 49.1 | 45.3 | 49.1 |
| Crosslinker PS1 | 5 | — | 2 | — |
| (1.8 mmol/g SiH) | | | | |
| Crosslinker PS2 | 9 | — | 10.7 | — |
| (4.17 mmol/g SiH) | | | | |
| n(vinyl) [mmol/wt-%] | 7.4 | | 7.6 | |
| n(SiH) [mmol/wt-%] | 46.5 | | 48.2 | |
| Pyrogenic silica | 2.6 | 3.5 | 2.6 | 3.5 |
| Crystalline SiO₂ | 36.3 | 42.4 | 36.3 | 42.4 |
| Silicopolyester surfactant | 3.1 | — | 3.1 | — |
| Silicone oil (10 mPas) | — | 3.5 | — | 3.5 |
| Pigment | — | 0.6 | — | 0.6 |
| Pt catalyst | — | 0.4 | — | 0.4 |
| Pd dispersion | — | 0.5 | — | 0.5 |

| | | |
|---|---|---|
| SiH/vinyl: molar ratio | 6.3 | 6.4 |
| t₅ / min | 1.48 | 1.36 |
| (t₉₀ − t₅ ) / min | 0.5 | 0.5 |
| ΔT / ° C. | 2.8 | 2.9 |
| PS1:PS2 weight ratio | 1:1.8 | 1:5.4 |

TABLE 6

| | Example 6 | | Example 7 | |
|---|---|---|---|---|
| | Base | Catalyst | Base | Catalyst |
| | [wt.-%] | [wt.-%] | [wt.-%] | [wt.-%] |
| PDMS mixture Oil | 47.8 | 49.1 | 48.8 | 49.1 |
| Crosslinker PS1 | 3.5 | — | 1.4 | — |
| (1.8 mmol/g SiH) | | | | |
| Crosslinker PS2 | 6.7 | — | 7.8 | — |
| (4.17 mmol/g SiH) | | | | |
| n(vinyl) [mmol/wt-%] | 7.9 | | 8.0 | |
| n(SiH) [mmol/wt-%] | 34.2 | | 35.0 | |
| Pyrogenic silica | 2.6 | 3.5 | 2.6 | 3.5 |
| Crystalline SiO₂ | 36.3 | 42.4 | 36.3 | 42.4 |
| Silicopolyester surfactant | 3.1 | — | 3.1 | — |
| Silicone oil (10 mPas) | — | 3.5 | — | 3.5 |
| Pigment | — | 0.6 | — | 0.6 |
| Pt catalyst | — | 0.4 | — | 0.4 |
| Pd dispersion | — | 0.5 | — | 0.5 |

| | | |
|---|---|---|
| SiH/vinyl: molar ratio | 4.3 | 4.4 |
| t₅ / min | 1.57 | 1.45 |
| (t₉₀ − t₅ ) / min | 0.5 | 0.5 |
| ΔT / ° C. | 2.9 | 2.8 |
| PS1:PS2 weight ratio | 1:1.91 | 1:5.57 |

The compositions according to the invention provide fast-setting compositions that have very short time windows for the curing reaction t₉₀−t₅ of, in particular, t₉₀−t₅ less than or equal to 0.8, while at the same time avoiding excessive temperature increases. The temperature increase of the compositions according to the invention is preferably less than 7° C., more preferably less than or equal to 6° C., and particularly preferably less than or equal to 5° C.

1. Curable composition comprising addition-crosslinkable organofunctional polysiloxanes comprising
i. addition-crosslinking polysiloxanes comprising at least two terminal ethylene groups and
ii. polysiloxanes comprising at least two Si—H groups, wherein
the polysiloxanes comprising Si—H groups comprise at least two polysiloxane compositions with different contents of Si—H groups, wherein a first polysiloxane composition (PS1) has a content of Si—H groups of 1 to 3.5 mmol/g and a second polysiloxane composition (PS2) has a Si—H group content of 3.8 mmol/g to 15 mmol/g, wherein the first polysiloxane composition (PS1) with a Si—H group content and the second polysiloxane composition (PS2) having a Si—H group content in a weight ratio of 1:1.5 to 1:10, and
wherein the molar ratio of Si—H groups of the polysiloxanes to ethylene groups of the polysiloxanes is from 4:1 to 10:1, and optionally comprising a hydrosilylation catalyst, wherein the curable composition comprises essentially no monounsaturated compound of formula I 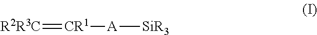
with
R each independently selected from H, monovalent alkyl group with 1 to 22 C atoms, aryl group with 16 to 12 C atoms, O—SiR⁴₃ group, wherein
R optionally comprises hetero atoms, with the provision that R is not an alkoxy group or arylalkoxy group,
R¹, R², R³ are each independently selected from H, monovalent alkyl group with 1 to 22 C atoms, aryl group with 6 to 12 C atoms and optionally each independently comprise hetero atoms,
R⁴ is a monovalent alkyl group with 1 to 22 carbon atoms or an aryl group with 6 to 12 carbon atoms, wherein optionally two or three R⁴ radicals form a cyclic or polycyclic structure in O—SiR⁴₃,
A is a bivalent linear, branched or cyclic hydrocarbon group with 1 to 12 C atoms, optionally comprising an aromatic with at least one methylene group which is directly covalently bonded to the aromatic, optionally comprising —O-atoms.

2. Composition according to claim 1, wherein the addition-crosslinking polysiloxanes comprising at least two terminal ethylene groups comprise polydialkylsiloxanes, polydialkylsiloxane ethers or mixtures thereof, with alkyls each independently having 1 to 16 carbon atoms.

3. Composition according to claim 1, wherein the
maximum temperature increase (ΔT) during curing is less than or equal to 7° C., wherein the temperature increase is measured with a temperature sensor in the mass in a time interval of 15 seconds from the first mixing to 10 minutes after the first mixing.

4. Composition according to claim 1, wherein the (i) maximum temperature increase (ΔT) during curing is less than or equal to 6° C., where the temperature increase is measured with a temperature sensor in the mass at a time interval of 15 seconds from the first mixing until 10 minutes after the first mixing in particular, a temperature measurement is taken every 30 seconds, and/or
(ii) the value t₅ in minutes of the complex viscosity of 5% of the complex viscosity of the value of the complex viscosity 10 minutes after the start of mixing of the curable composition, is less than or equal to 1.7 minutes, and/or
(iii) the value t₉₀−t₅ as the difference between the time t₉₀ at 90% of the complex viscosity of the complex viscosity value reached after 10 minutes and the time t₅ at 5% of the complex viscosity of the complex viscosity value reached after 10 minutes is less than or equal to 1 minute.

5. Composition according to claim 1, wherein the composition does not comprise any amount of any tetraallylsilane.

6. Composition according to claim 1, wherein it comprises at least one surfactant comprising a polyether, polyether-functionalized siloxane oligomer, fatty alcohol and/or fluorosurfactant or mixtures of the aforementioned surfactants.

7. Composition according to claim 1, wherein the addition-crosslinking polysiloxanes comprising at least two terminal ethylene groups with a content of ethylene groups of 0.01 mmol/g to 10 mmol/g ethylene groups, in particular vinyl groups.

8. Composition according to claim 1, wherein
the first polysiloxane composition (PS1) has a Si—H group content of 1 to 3.0 mmol/g.

9. Composition according to claim 1, wherein
the second polysiloxane composition (PS2) has a Si—H group content of 3.9 mmol/g to 10 mmol/g.

10. Composition according to claim 1, wherein the molar ratio of Si—H groups of the polysiloxanes to ethylene groups of the polysiloxanes is from
3.5:1 to 10:1.

11. Composition according to claim 1, wherein the first and second polysiloxane compositions are present as a mixture, wherein the first polysiloxane composition (PS1) and the second polysiloxane composition (PS2) are present in a weight ratio of 1:3 to 1:10.

12. Composition according to claim 1, wherein the first polysiloxane composition (PS1) and the second polysiloxane composition (PS2) are present in a weight ratio of 1:1.5 to 1:2.2.

13. Composition according to claim 1, wherein the curable composition is obtainable by mixing two components to obtain an addition-crosslinkable curable composition,
wherein the two components comprise:
a) base components comprising addition-crosslinkable polysiloxanes containing at least two ethylene-groups and polysiloxanes containing Si—H-groups, and polydialkylsiloxanes containing at least two Si—H-groups polydialkylsiloxanes, and
b) catalyst component comprising a platinum, rhodium and/or palladium comprising hydrosilylation catalyst, and
optionally comprising addition-crosslinking polysiloxanes comprising at least two terminal ethylene groups and optionally at least comprising polysiloxanes with at least two Si—H groups,
and optionally wherein the base component and/or the catalyst component each independently comprising
inorganic fillers or organic particulate polymers.

14. Composition according to claim 1, wherein
the polydialkylsiloxanes comprising at least two terminal ethylene-groups are selected from vinyl-terminated polydialkylsiloxanes and vinyl-terminated polyether-functional polydialkylsiloxanes.

15. Composition according to claim 1, wherein
the polydialkylsiloxanes comprising at least two Si—H-groups are selected from polydialkylsiloxanes and polyether-functional polydialkylsiloxanes, which have terminal Si—H groups and optionally containing in —Si(CH₃)H groups the polysiloxane backbone, in particular the polydialkylsiloxanes containing Si—H-groups are selected from polydimethylsiloxanes and polyether-functional polydimethylsiloxanes, wherein the polydialkylsiloxanes contain terminal Si—H-groups and optionally comprising —Si(CH₃)H groups in the polysiloxane backbone.

16. Composition according to claim 1, wherein
the composition is obtainable by mixing a
i) base component and
ii) catalyst component, wherein
i) the base component comprises
30 to 50 wt.-% of polydialkylsiloxanes comprising at least two terminal ethylene groups,
ii) the catalyst component comprises
20 to 80 wt.-% of polydialkylsiloxanes comprising at least two terminal ethylene groups, and
wherein the ratio of terminal ethylene groups of the base component to terminal ethylene groups of the catalyst component is in a molar ratio of 1:1.1 to 1:10.

17. Composition according to claim 1, wherein
the composition is obtainable by mixing a
i) base component and
ii) catalyst component, wherein
i) the base component comprises
30 to 50 wt.-% of polydialkylsiloxanes comprising at least two terminal ethylene-groups,
15 to 64 wt.-% inorganic fillers,
5 to 30 wt.-% of polydialkylsiloxanes comprising at least two Si—H groups,
1.0 to 15 wt.-% of at least one surfactant, and
where the total amount of the base component is 100 wt.-%, and
ii) the catalyst component comprises
20 to 80 wt.-% of polydialkylsiloxanes comprising at least two terminal ethylene groups,
5 to 70 wt.-% inorganic fillers,
0.001 to 5.0 wt.-% of a hydrosilylation catalyst comprising platinum, rhodium or palladium,
0 to 15 wt.-% of at least one surfactant, and
0 to 10 wt.-% organic or inorganic pigments and/or structuring agents,
wherein the total amount of the catalyst components is 100 wt.-%.

18. Kit comprising a 2K dispensing device comprising at least two cartridges, wherein one cartridge comprises i) the base component according to claim 13 and the second cartridge comprises ii) the catalyst components according to claim 13.

19. Method of use of a composition according to claim 1 or a kit according to claim 18 by mixing i) a base component and ii) a catalyst component for making impressions in the medical field, dental field and/or veterinary field, for making impressions in the field of botany, for making impressions in the marine and aquatic field, for making impressions of surfaces of articles, for making impressions of designs, art or handcraft objects, as a dental impression material, as an impression material for human, veterinary or marine soft (tissue) and/or hard structures (bones, shells, coral), oral impressions, podiatry, for making impressions of electronic components, for making impressions of objects whose surfaces are wetted with aqueous compositions or whose surfaces are wetted with water, and/or for printing three-dimensional structures, particularly in the semiconductor field.

20. Composition according to claim 1, wherein the
addition-crosslinking polysiloxanes comprising at least two terminal ethylene groups comprise polydimethylsiloxanes, polydimethylsiloxane ethers or mixtures thereof.

21. Composition according to claim 7, wherein the addition-crosslinking polysiloxanes comprising at least two terminal vinyl-groups with a content of vinyl-groups of 0.01 mmol/g to 10 mmol/g vinyl groups.

22. Composition according to claim 8, wherein
the first polysiloxane composition (PS1) has a Si—H group content of 1.4 to 2.5 mmol/g.

23. Composition according to claim 9, wherein the second polysiloxane composition (PS2) has a Si—H group content of 4.1 to 5.0 mmol/g.

24. Composition according to of claim 13, wherein the curable composition is obtainable by mixing two components to obtain an addition-crosslinkable curable composition,
wherein the two components comprise:
a) base component comprising addition-crosslinkable polydialkylsiloxanes containing at least two ethylene-groups and polysiloxanes containing Si—H-groups, and polydialkylsiloxanes containing at least two Si—H-groups, and
b) catalyst component comprising a platinum, rhodium and/or palladium comprising hydrosilylation catalyst, and
optionally comprising addition-crosslinking polydialkylsiloxanes comprising at least two terminal ethylene groups and optionally at least comprising polysiloxanes with at least two Si—H groups,
and wherein the base component and/or the catalyst component each independently comprising
inorganic fillers or organic particulate polymers.

25. Composition according to claim 14, wherein the polydialkylsiloxanes comprising at least two Si—H-groups are selected from polydimethylsiloxanes and polyether-functional polydimethylsiloxanes, which have terminal Si—H groups and containing in —Si(CH₃)H groups the polysiloxane backbone.
